(19) United States
(12) Patent Application Publication
(10) Pub. No.: US 2006/0236040 A1
(43) Pub. Date: Oct. 19, 2006

(54) Multiprocessor system for preventing starvation in case of occurring address competition and method thereof

(76) Inventors: Keitaro Uehara, Kokubunji (JP); Jun Okitsu, Kokubunji (JP); Yoshiki Murakami, Hadano (JP); Takashi Miyata, Zama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/405,545

(22) Filed: Apr. 18, 2006

(30) Foreign Application Priority Data
Apr. 19, 2005 (JP) 2005-120487

(51) Int. Cl. G06F 12/00

(52) U.S. Cl. 711/150

(57) ABSTRACT

A case occurs in which a preceding transaction to be retried cannot be retried as a result of snooping. If the snoop result is waited for so that a retry decision may be made after the result of snoop has been obtained, latency is prolonged to urge the pipeline to have a variable length, thus complicating the logic. A transaction determined to be retried in the phase of issue of a request is discriminated from a transaction in course of issue and when a transaction representing a starvation protection object sequentially competes twice with the transaction in course of retry decision, the transaction of starvation protection object is issued to thereby eliminate starvation.

### CLAIM OF PRIORITY

The present application claims priority from Japanese application JP2005-120487 filed on Apr. 19, 2005, the content of which is hereby incorporated by reference into this application.

### BACKGROUND OF THE INVENTION

The present invention relates to a multiprocessor system and its chip set and more particularly, to a technology for deciding retry of transactions with the aim of preventing address competition and starvation.

As the performance of computers has been improved and demands for the computers have been increased concomitantly in recent years, a multiprocessor system incorporating a plurality of processors has been found frequently and widely in the field of, especially, a server. In this type of multiprocessor system, a plurality of transactions are issued at a time to the system through a process called delay response/out of order control in order to improve the parallelism and the transactions can be completed in different order from that of issuance.

The out of order control is valid limitedly for only a case where orders of execution of the plural transactions are independent of one another. If read and write or a plurality of operations of write destined for the same address are issued from different processors, processing of such transactions through the process of out of order results in different results depending on order of processing. Accordingly, a chip set incorporated in this type of multiprocessor system is required to have the function of deciding address competition (typically, in unit of cache line) and retrying a request destined for the same line as that of a transaction, which has already been issued to the system, without issuing the request to the system. The transaction determined to be retried will be reissued from the processor and will then be issued to the system after the preceding transaction has been completed.

Meanwhile, with a transaction determined to be retried, there is a possibility that depending on the timing at which the transaction is issued, retry of the transaction is subdued constantly by a different transaction issued from another processor, giving rise to so-called starvation. For example, an instance will sometimes proceed in which when there are four processors and one of them issues write with the three remaining ones issuing read, the retry of the initial write is done under the influence of constant interference with read by any one of the remaining processors. In such an event, other reads possibly wait for the result of the write through polling and therefore, with the write starved, the program cannot proceed any more, resulting in live lock.

As will be seen from the above, the chip set in the multiprocessor system must have the function of not only retrying in compensation for address competition but also preventing starvation.

U.S. Pat. No. 6,738,869 discloses a chip set for use in a multiprocessor system having the starvation prevention function. The chip set has an out-of-order coherency (OOC) queue for storing addresses of transactions issued to the system and a write starvation prevention (WSP) queue for storing only one write transaction placed in starvation condition. Upon issuing a transaction, address comparison is made in valid entries of the OOC queue and in the presence of an entry in competition, retry is determined. With a write transaction determined to be retried, the corresponding address is stored in the WSP queue if the WSP queue is unoccupied. Then, a read transaction in competition with the address stored in the WSP queue is caused to be subject to retry. In this manner, preferential issuance of the write transaction can be assured and the occurrence of starvation can be avoided.

On the other hand, Intel (R) Itanium (R) 2 Processor Hardware Developer's Manual introduces typical bus specifications of a processor. This reference describes that when HITM is asserted on a processor bus in the snoop phase by a different processor, inter-cache communication (C2C) is executed in which the latest data is transferred to a requester from a cache the asserting processor has.

As will be seen from the above, the starvation prevention can be realized in such a way that until a transaction targeted by preventive protection from starvation can be passed without being retried, other transactions in address competition are retried. Depending on specifications of the processor bus, however, a case exists in which a transaction so determined as to be capable of being retried in the phase of request will be found later incapable of being retried in effect. This will be explained by taking the bus specifications in the aforementioned U.S. Pat. No. 6,738,869, for instance. In the request phase, information indicative of transaction type and address is informed to the processor bus. Thereafter, in the snoop phase, the result of snoop carried out for the transaction by a different processor is informed. The snoop result includes a signal called HIT indicative of the possession or sharing of a clean cache copy for read transactions and a signal called HITM indicative of the possession of a dirty cache for either read or write transactions (in the event that no copy is possessed, neither HIT nor HITM is asserted). With the HITM asserted in this scheme, the latest data is present in the cache and hence, read of data from the memory is unnecessary and the latest data in the cache is transferred directly to a requester. This is called inter-cache transfer (C2C). Since the inter-cache transfer signifies completion of transaction on the processor bus, retry never prevails. Meanwhile, in the case of the occurrence of inter-cache transfer, the chip set needs to perform back-write of the latest data to the memory and therefore, it must issue a transaction to the system. Accordingly, until the back-write transaction to the memory concomitant with the inter-cache transfer has been completed, succeeding transactions destined for the same address are required to be retried.

As described above, a case exists in which a transaction permitted for retry in the request phase is prohibited from retry in the snoop phase. Consequently, a transaction cannot be determined as to whether to be retried in effect until the result of snoop phase is examined. The snoop phase is, however, retarded by three cycles or more in terms of bus cycle from the request phase and the retardation will be accelerated in the event of a snoop stall, raising a problem that when the decision is made following reception of the result of the snoop phase, latency up to the issuance of the transaction in the absence of retry is prolonged. In making an attempt to make the decision before the snoop phase, decision as to the competition of the succeeding transaction destined for the same address must be retarded and disadvantageously, the length of a pipeline is required to be variable and the address competition decision logic is complicated.

### SUMMARY OF THE INVENTION

An object of the present invention is to decide the address competition/starvation without waiting for the result of snoop phase by using a pipeline of fixed length to thereby realize the issue of a transaction through low latency on the basis of simplified logic.

According to this invention, to accomplish the above object, in-course-of-retry bits indicative of transactions in course of retry decision are provided in individual entries of an address store buffer for managing addresses of transactions in course of issue. When retrieving the address store buffer, a retry decision unit decides one of three states including competition with only entries set with in-course-of-retry bits, competition with entries not set with in-course-of-retry bits and competition with no entry.

If a transaction is in competition with an entry in the address store buffer or in competition with an address of a transaction subject to starvation prevention by a different issuer, the retry decision unit determines that the transaction is to be retried and sets the address in the address store buffer after setting an in-course-of-retry bit. In case retry is not determined, an address is stored after clearing an in-course-of-retry bit.

A starvation prevention control unit includes a queue for storing an issuer of a transaction representing a starvation prevention object and its address, a NOFLIGHT bit indicative of the absence of a transaction in course of issue destined for an address of an object subject to starvation prevention at present, and a READY bit indicating that a transaction representing a starvation prevention protection is permitted for issue when the transaction does not compete with an entry not set with an in-course-of-retry bit.

When a transaction representing a starvation prevention object competes with only an entry set with an in-course-of-retry bit during retrieval of the address store buffer, the starvation prevention control unit does not retry the transaction but issues it to the system if both the NOFLIGHT and READY bits are “1”. Otherwise, the starvation prevention control unit sets the NOFLIGHT bit to “1” and sets the READY bit to “1” if retry is permissible as a result of the snoop phase. On the other hand, when a transaction representing a starvation prevention object competes with an entry not set with an in-course-of-retry bit during retrieval of the address store buffer, both the NOFLIGHT and READY bits are cleared to “0”.

The retry decision unit also receives the result of snoop of a transaction and in the case of prohibition of retry, clears an in-course-of-retry bit in the corresponding entry of the address store buffer.

Through a series of operations as above, the starvation prevention and the retry due to address competition can be realized without waiting for the result of snoop of the preceding transaction.

According to the present invention, decision of retry due to address competition can be effected without waiting for the result of snoop. The latency proceeding up to issue when a transaction is not retried can be shortened by 2 to 3 cycles. In addition, the address competition decision unit can be constructed of a pipeline of fixed cycle. The gate scale can then be reduced as compared to the variable length pipeline for making the address competition decision after obtaining the result of retry of the preceding transaction.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing the overall construction of first/third embodiments of the present invention.

FIG. 2 is a time chart in a case where an HITM signal of the preceding unprotected Tx is not asserted in the first embodiment of the invention.

FIG. 3 a time chart in a case where an HITM signal of the preceding unprotected Tx is asserted in the first embodiment of the invention.

FIG. 4 is a block diagram showing the overall construction of a second embodiment of the invention.

FIG. 5 is a diagram showing a structure of request 600.

FIG. 6 is a table showing classification of transaction type 710.

FIG. 7 is a table showing classification of snoop result 610.

FIG. 8 is a table showing classification of response 620.

FIG. 9 is a basic flowchart of request phase in the third embodiment of the invention.

FIG. 10 is a flowchart showing details of step 1010 “retrieval of address store buffer 300”.

FIG. 11 is a flowchart showing details of step 1020 “retrieval of starvation prevention control unit 400”.

FIG. 12 is a flowchart showing details of step 1040 “issue registration”.

FIG. 13 is a flowchart showing details of step 1050 “retry registration”.

FIG. 14 is a basic flowchart of snoop phase in the third embodiment of the invention.

FIG. 15 is a flowchart showing details of step 1380 “issue process”.

FIG. 16 is a flowchart showing details of step 1390 “retry process”.

FIG. 17 is a basic flowchart of completion phase in the third embodiment of the invention.

### DESCRIPTION OF THE EMBODIMENTS

### 1. Embodiment 1

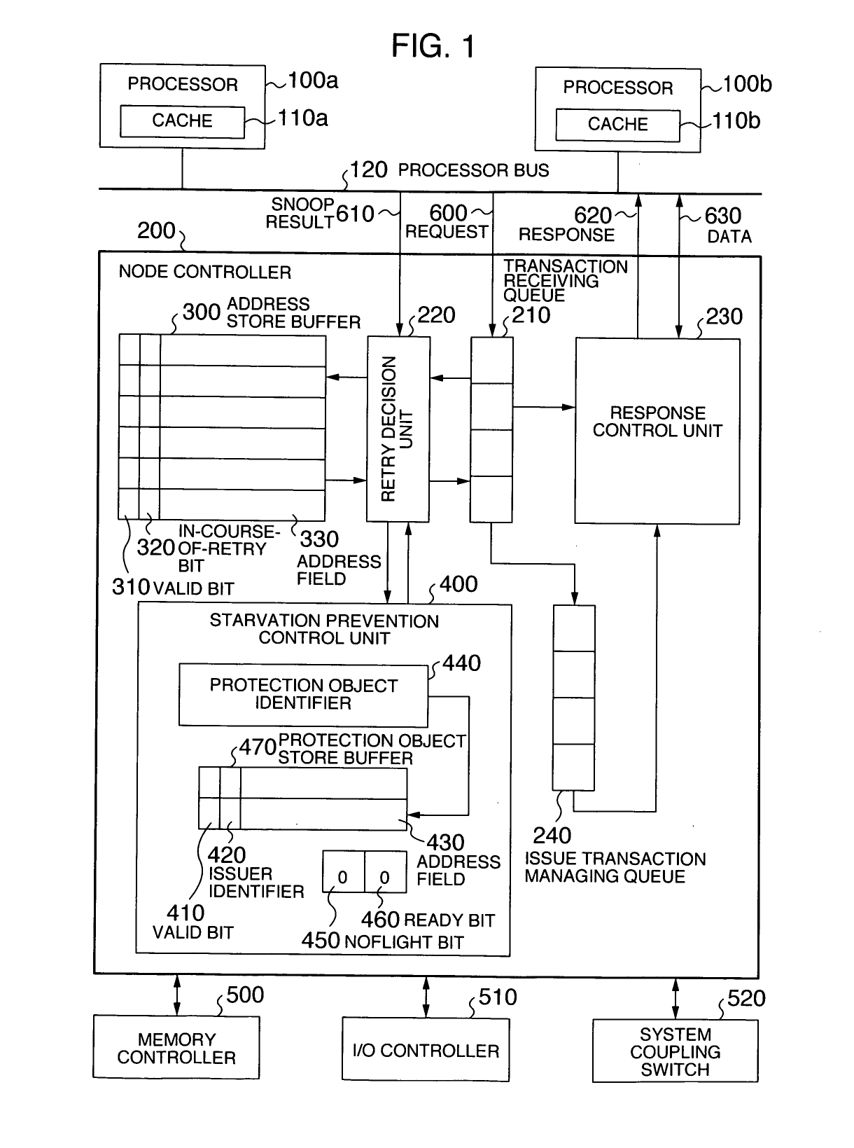

Referring now to FIGS. 1 to 3, a first embodiment of the present invention will be described. A multiprocessor system according to the first embodiment is schematically constructed as illustrated in block diagram form in FIG. 1, principally showing a node controller having the address competition decision function characteristic of the present embodiment. Processor bus 120, memory controller 500, I/O controller 510 and system coupling switch 520 are mutually coupled through the node controller as designated at 200. Though not depicted explicitly, the memory controller 500 is headed by a main memory and the I/O controller 510 is headed by an I/O bus which in turn is headed by the coupling to a plurality of I/O devices, not shown. A plural-node configuration will also be possible in which a plurality of node controllers are coupled together by means of the system coupling switch 520. The following description does not differ with the number of nodes.

Two or more processors 100 are coupled to the processor bus 120. The processor 100 includes a cache 110. The processor is so termed as to be expressed explicitly herein but each processor may be constructed in the form of a multi-core having two or more processor cores in one processor. A description to be given hereinafter will remain in entity even if the processor core rephrases the processor.

The node controller 200 includes a transaction receiving queue 210 for storing a transaction issued to the processor bus 120, an address store buffer 300 for storing an address of the transaction in course of issue, a starvation prevention control unit 400 for controlling starvation prevention, a retry decision unit 220 for deciding retry on the basis of the result of retrieval of address store buffer 300 or of starvation prevention control unit 400 and the result of snoop obtained from the processor bus 120, an issue transaction managing queue 240 for managing an issue transaction, and a response control unit 230 for returning a response to the processor bus 120.

Each entry of address store buffer 300 has fields of valid bit 310, in-course-of-retry bit 320 and address 330. The starvation prevention control unit 400 has a protection object store buffer 470 comprised of one or more entries. Each entry of protection object store buffer has fields of valid bit 410, issuer (originator) identifier 420 and address 430. The starvation prevention control unit 400 also has a protection object identifier 440 indicative of an object subject to starvation prevention protection at present. Structurally, the protection object store buffer 470 may be either a queue or a bit map having entries corresponding to different issuer identifiers. The structural difference in protection object store buffer 470 does not make the following description differ. The starvation prevention control unit 400 further has a NOFLIGHT bit 450 indicative of the absence of a presently issued transaction destined for an address targeted by protection of starvation prevention and, a READY bit 460 indicating that a transaction subject to starvation prevention protection can be issued on the next opportunity.

The issuer identifier 420 can be used not only for a processor having issued a transaction subject to protection but also for discriminating types (read/write) of issued transactions. Even transactions issued from the same processor are distinctively considered in such a way that a transaction for read and that for write are deemed as being issued from different issuers to personate separate protection objects. The write transaction referred to herein includes a transaction for pure write as well as a read transaction for writing on the cache (a read invalidate transaction).

Operation of starvation prevention and address competition decision in the first embodiment will be described by making reference to FIG. 1.

Immediately after resetting, the valid bits 310 in address store buffer 300 are all initialized to “0” and besides the valid bits 410 in protection object store buffer 470 of the starvation prevention control unit 400 are all initialized to “0”. In addition, both the NOFLIGHT bit 450 and READY bit 460 in the starvation prevention control unit 400 are initialized to “0”.

When the processor 100a makes a request for a transaction issue, a request phase is started on the processor bus 120. The node controller 200 receives this transaction issue request and stores necessary information concerning the transaction in the transaction receiving queue 210. The information necessary for the transaction includes issuer processor, address, transaction type and delay response ID.

Receiving the transaction, the node controller 200 retrieves the address store buffer 300 to determine whether the corresponding address is present. In this phase, retrieval is done in connection with only the entries having the valid bit 310 being “1”. Then, in respect of an entry having the valid bit 310 being “1”, the field of address 330 is compared with an address of the transaction and when the comparison result shows an access to the same memory resource (normally, decision is made in unit of cache line), address competition is determined. At that time, “Weak Retry” state is determined if the address competition occurs in only an entry having the in-course-of-retry bit 320 being set, “Retry” state is determined if the address competition occurs in one or more entries having the in-course-of-retry bit 320 not being set and “OK” state is determined if the address competition does not occur in any one of the entries, and the address store buffer 300 responds to the address retrieval request by making a response in any one of the above forms of state.

The starvation prevention control unit 400 is also requested for retrieval. When in the starvation prevention control unit 400 one or more entries having valid bit 410 being set are present on the protection object store buffer 470 and the protection object identifier 440 designates one of the entries, an address in the designated entry is placed in condition of protection. Then, if an address of a transaction received differs from an address in the field of address 430 of starvation protection object, nothing takes place, followed by making a response of “OK”. If the address of the received transaction is the same as an address in the field of address 430 of an entry designated by the protection object identifier 440, an issuer of the received transaction is compared with an issuer identifier in the field of issuer identifier 420 of the starvation protection object. If coincidence is held, the starvation protection object is responded as being “OK”. If non-coincidence stands, “Retry” is responded.

The retry decision unit 220 receives the response results of address store buffer 300 and starvation prevention control unit 400 to decide whether the received transaction is to be retried. If either response is “Retry”, the transaction is determined as being retried. If both the responses are “OK”, the transaction is determined as being permissible for issue. In case the transaction is one representing a starvation prevention object and the response result of address store buffer 300 is “Weak Retry”, the retry decision unit 220 further checks status of NOFLIGHT bit 450 and READY bit 460 in the starvation prevention control unit 400. If both the NOFLIGHT bit 450 and READY bit 460 are “1”, the transaction is determined not to be retried but to be permitted for issue. If any one of them is “0”, the transaction is determined to be retried and the NOFLIGHT bit 450 is set to “1”.

If the transaction targeted by starvation protection is determined for “Retry” in accordance with the response result of address store buffer 300, The NOFLIGHT bit 450 and READY bit 460 are both cleared to “0”.

The retry decision unit 220 registers the received transaction in the address store buffer 300. If retry is determined in this phase, the fields of valid bit 310 and in-course-of-retry bit 320 in the entry are both rendered “1” for registration. If not retry but permission for issue is determined, only the valid bit 310 is set to “1” in the entry with the in-course-of-retry bit 320 being set to “0” for registration. Till now, the node controller 200 proceeds with operation in the request phase.

Next, operation of the snoop phase will be described. After several cycles following the request phase, a different processor 100 on the processor bus 120 makes a response of the result of snooping the issued transaction request. In accordance with the snoop result, the node controller 200 finally decides whether the transaction is to be issued or retried. In case the different processor 100b has in its cache 110b data newer than that in the memory, the processor 110b returns to the processor bus 120 a snoop result of HITM. The node controller 200 receiving the HITM must return an HITM response to the processor bus 120 in order that the transaction can be completed through inter-cache transfer. At that time, even a transaction determined to be retried in the request phase is prohibited from retry and must be subject to the HITM response. Receiving the HITM signal, the retry decision unit 220 clears the in-course-of-retry bit 320 of the entry corresponding to the transaction in address store buffer 300. The transaction is de-queued from the transaction receiving queue 210 and in order to issue to the system a transaction for back-write of the latest cache data (write-back transaction) to the memory, the write-back transaction is en-queued to the issue transaction managing queue 240. The response control unit 230 returns the HITM response to the process bus 120. In case the transaction is one targeted by the starvation protection, the valid bit 410 of the entry corresponding to the transaction in protection object store buffer 470 of the starvation prevention control unit 400 is cleared and the NOFLIGHT bit 450 and READY bit 460 are also cleared. Then, the protection object identifier 440 is changed to a different valid entry in the protection object store buffer 470.

With the snoop result not being HITM, the retry decision unit 220 determines retry of a transaction depending on whether retry is determined in the request phase. If retry has not been determined, the transaction is de-queued from the transaction receiving queue 210 and en-queued to the issue transaction managing queue 240. In case the transaction is one targeted by starvation prevention, the valid bit 410 of corresponding entry in starvation prevention control unit 400 is cleared and the NOFLIGHT bit 450 and READY bit 460 are also cleared to “0”. In addition, the protection object identifier 440 is changed to a different valid entry in the protection object store buffer 470. The response control unit 230 returns the normal response (delay response) to the processor bus 120.

When the snoop result is determined not to be HITM and the retry decision unit 220 has determined retry in the request phase, the transaction is retried. The retry decision unit 220 clears to 0 the valid bit 310 of the corresponding entry in the address store buffer 300. In the starvation prevention control unit 400, when the corresponding issuer identifier is not registered in the protection object store buffer 470 and an unoccupied entry is present, address and issuer identifier of the transaction are registered in the protection object store buffer 470 and the valid bit 410 in the corresponding entry is set. In case the transaction is one targeted by starvation protection and the NOFLIGHT bit 450 is set, the READY bit 460 is also set. The transaction is de-queued from the transaction receiving queue 210. The response control unit 230 returns a retry response to the processor bus 120. Through the above operation, the starvation prevention and address competition decision of the transaction can be assured.

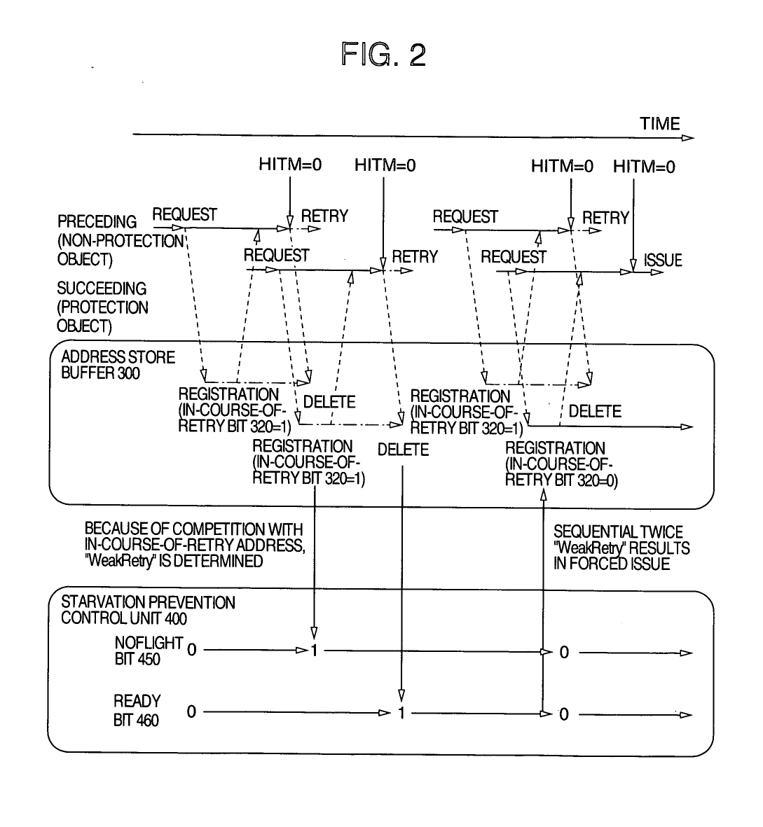

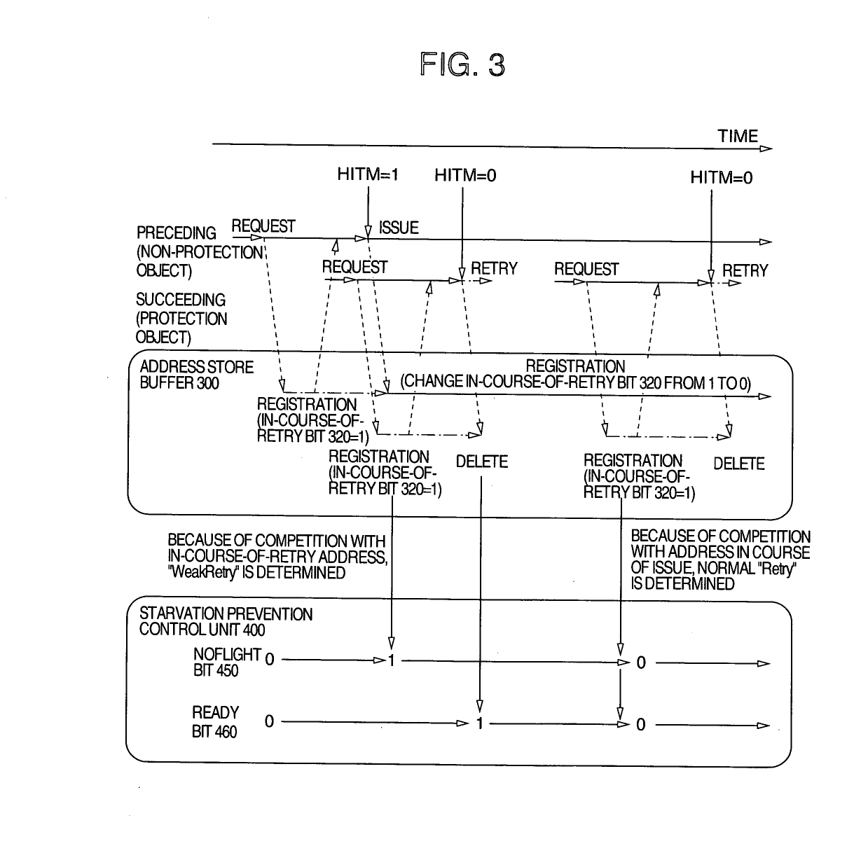

Referring now to FIGS. 2 and 3, a description will be given to demonstrate that the starvation prevention and retry decision can be carried out correctly when an address competition occurs between a transaction not subject to starvation protection and a transaction subject to starvation protection. Illustrated in FIGS. 2 and 3 are time charts which proceed from left to right with time.

Shown in FIG. 2 is a case where a transaction from an issuer not subject to starvation protection and is in competition with an address of a starvation protection object (hereinafter referred to as a non-protection object) is issued in advance, a transaction subject to starvation protection from an issuer subject to starvation protection (hereinafter referred to as a protection object) is issued subsequently and the HITM of the preceding transaction of non-protection object is not asserted. Assumptively, the protection object identifier 440 of starvation protection control unit 400 indicates read by the processor 100b, and the transaction of non-protection object is issued from the processor 100a and the transaction of protection object is issued from the processor 100b.

Firstly, the transaction of non-protection object is issued from the processor 100a. Since the result of retrieving the starvation prevention control unit 400 shows that the transaction of non-protection object having an address coincident with that of the transaction of protection object is issued from an issuer different from that of the transaction of protection object, the retry decision unit 200 determines retry, thus registering the transaction of non-protection object into the address store buffer 300 while setting the in-course-of-retry bit 320a.

Subsequently, the succeeding transaction subject to protection is issued from the processor 100b. Since the result of retrieving the starvation prevention control unit 400 shows that the transaction represents a protection object, the starvation prevention control unit 400 makes a response “OK”. But the result of retrieving the address store buffer 300 shows that there occurs address competition with the preceding transaction for which the in-course-of-retry bit 320a is set, so that the address store buffer 300 makes a response “Weak Retry”. The retry decision unit 220 receiving the result “Weak Retry” checks the NOFLIGHT bit 450 and READY bit 460 in the starvation prevention control unit 400 to determine that both of them are “0”, thereby determining the transaction to be retried. At that time, the NOFLIGHT bit 450 is set to “1”. The transaction subject to protection is registered in the address store buffer 300 while the in-course-of-retry bit 320b being set.

Subsequently, the snoop phase for the preceding transaction of non-protection object proceeds and the retry decision unit 220 knows from the result of snoop that the HITM is not asserted. Following the result of decision in the request phase, the retry decision unit 220 determines the transaction to be retried and clears to “0” the valid bit 310a of the corresponding entry in address store buffer 300.

Subsequently, the succeeding transaction of protection object undergoes the snoop phase and the retry decision unit 220 knows from the result of snoop that the HITM is not asserted, either. Following the result of decision in the request phase, the retry decision unit 220 determines the transaction to be retried and clears to “0” the valid bit 310b of the corresponding entry in the address store buffer 300. In addition, since the transaction is one subject to starvation prevention protection, the retry decision unit checks the NOFLIGHT bit 450 in the starvation prevention control unit 400 and responsive to this bit being “1”, sets the READY bit 460 to “1”.

Both the transactions are determined to be retried and in due course, the request phase is restarted from the processor 100. The preceding transaction of non-protection object is issued from the processor 100a, again determined to be retried and registered in the address store buffer 300 while the in-course-of-retry bit 320c (which may be the same as or different from the 320a) being set. Subsequently, the succeeding transaction of protection object is issued from the processor 100b and the status till the determination of “Weak Retry” in the address store buffer 300 is quite the same as that in the first occurrence. This time, however, the NOFLIGHT bit 450 and READY bit 460 are both set in the starvation prevention control unit 400 and following the result “Weak Retry” and the two bits being both “1”, the retry decision unit 220 determines that the transaction is permissible for issue. Then, after reception of the result of snoop, the succeeding transaction of protection object is issued and the corresponding entry is deleted from the starvation prevention control unit 400. And also, the NOFLIGHT bit 450 and READY bit 460 are cleared. The above gives a description of the time chart when the HITM for the preceding transaction of non-protection object is not asserted.

A time chart shown in FIG. 3 illustrates a case substantially the same as that in FIG. 2, with the only exception that the HITM of a preceding transaction of non-protection object is asserted.

As in the case of FIG. 2, the protection object identifier 440 of starvation prevention control unit 400 indicates read by the processor 100a. Assumptively, a transaction of non-protection object is issued from the processor 100a and a transaction of protection object is issued from the processor 100b. Initially, the transaction of non-protection object is issued from the processor 100a. Since the result of retrieving the starvation protection control unit 400 shows that an address of the transaction of non-protection object coincides with an address of the transaction of protection object and the issuer of the transaction of non-protection object differs from that of the transaction of protection object, the retry decision unit 220 determines the transaction of non-protection object to be retried and registers it in the address store buffer 300 while the in-course-of-retry bit 320a being set.

Subsequently, the succeeding transaction of protection object is issued from the processor 100b. Since the result of retrieving the starvation prevention control unit 400 shows that the transaction of protection object prevails, the starvation prevention control unit 400 makes a response “OK”. But the result of retrieving the address store buffer 300 shows that its address is in competition with the address of the preceding transaction for which the in-course-of-retry bit 320a is set, the address store buffer 300 makes a response “Weak Retry”. Receiving the result of “Weak Retry”, the retry decision unit 220 checks the NOFLIGHT bit 450 and Ready bit 460 in the starvation prevention control unit 400 and because of the both bits being “0”, determines the succeeding transaction to be retried. At that time, the NOFLIGHT bit 450 is set to “1”. The transaction of protection object is registered in the address store buffer 300 with the in-course-of-retry bit 320b set. Till then, the procedure is quite the same as that in FIG. 2. Subsequently, it is assumed that the result of the phase of snooping the preceding transaction of non-protection object shows that the latest cache data exists in the cache 110c of a third processor 100c not illustrated. The processor 100c makes a response of HITM to a request from the processor 10a and the retry decision unit 220 knows assertion of the HITM. As a result, the retry decision unit 220 clears the in-course-of-retry bit 320a in the corresponding entry of address store buffer 300 to “0” in order to issue a write-back transaction corresponding to the preceding transaction of non-protection object to the system. Then, the transaction is de-queued from the transaction receiving queue 210 and the write-back transaction is en-queued to the issue transaction queue 240. The response control unit 230 returns an HITM response to the processor bus 120. Inter-cache transfer from cache 110c to cache 110a is carried out on the processor bus 120.

Subsequently, the result of snooping the succeeding transaction of protection object shows that HITM is not asserted and therefore, the retry decision unit 220 retries the transaction as determined in the request phase and clears the corresponding valid bit 320b in the address store buffer 300 to “0”.

Thereafter, the processor 100b reissues the transaction of protection object. The transaction is entrained in the transaction receiving queue 210 and the address store buffer 300 is retrieved. But, different from the preceding state, address competition now takes place with an entry having the valid bit 310a being “1” and the in-course-of-retry bit 320a being “0” (corresponding to the write-back transaction caused by the preceding transaction of non-protection object) and consequently, the result of retrieving the address store buffer 300 is not “Weak Retry” but is “Retry”. Therefore, irrespective of the values of NOFLIGHT bit 450 and READY bit 460 in the starvation prevention control unit 400, the transaction of protection object is determined as being retried.

Through a series of operations as above, it is proven that when the HITM of the preceding transaction of non-protection object is asserted, the succeeding transaction of protection object can be retried correctly.

Points characteristic of operation in the foregoing embodiment can be summed up as follows. An entry in which the in-course-of-retry bit 320 is set follows the result of snoop phase so as to be either retried or asserted for HITM. Accordingly, at the time that “Weak Retry” is determined in which address competition with only an entry for which the in-course-of-retry bit 320 is set occurs, it can be guaranteed that any transactions having the same address and being in course of issue to the system never exist. At that time, the NOFLIGHT bit 450 is set. Also, at that time, the possibility of being issued to the system is assured in any one of a case where the HITM of the preceding transaction is asserted and a case where the HITM of the transaction of protection object per se is asserted.

Next, responsive to the result of snoop not being HITM, the transaction of protection object per se loses the possibility of being asserted for HITM. Further, since snooping has ended, transactions to be issued thereafter have no possibility of being asserted for HITM. In this phase, the READY bit 460 is set. Only one remaining possibility is that the preceding transaction has been asserted for HITM. On the assumption that the preceding transaction has been asserted for HITM, not “Weak Ready” but “Retry” prevails at the time of reissue of the transaction of protection object and in such a case, retry will be determined. If “Weak Retry” remains unchanged even at the time of the second occurrence, there is no possibility that the transaction is issued to the system. This enables the transaction of protection object to be issued to the system.

The foregoing description has been dedicated to the first embodiment of the invention.

### 2. Second Embodiment

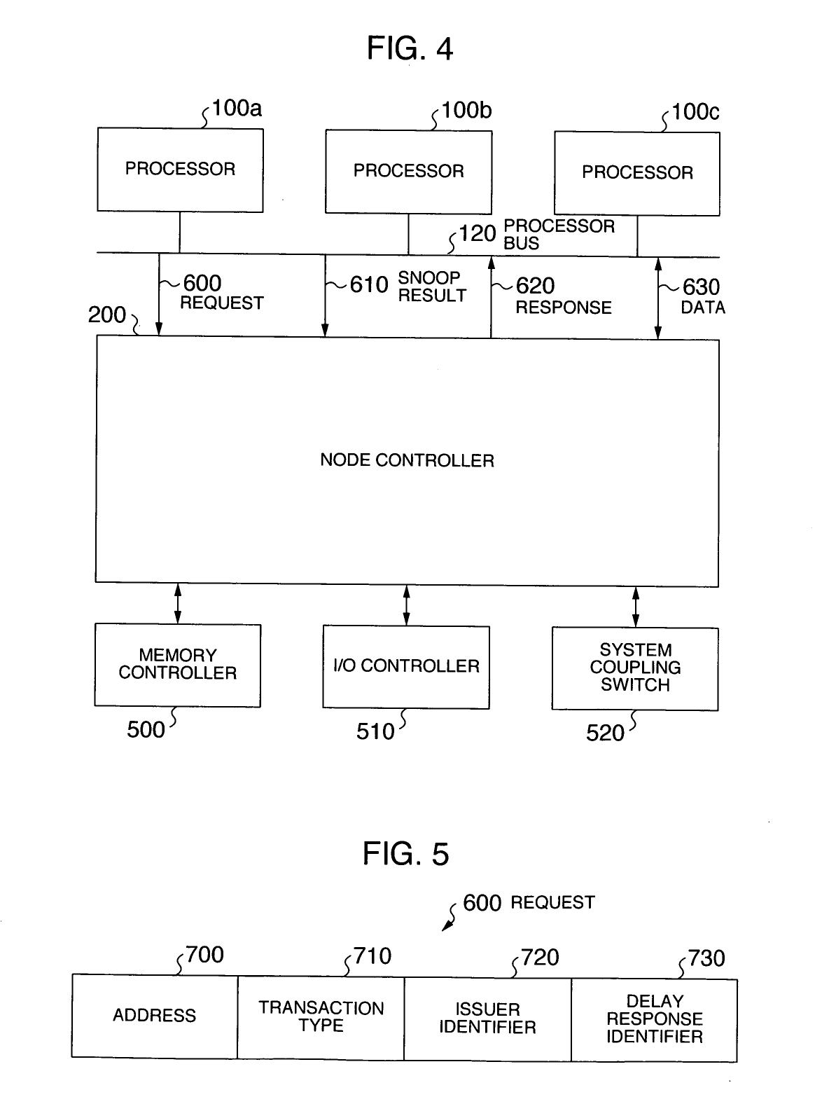

A second embodiment of the present invention will now be described with reference to FIGS. 4 to 8.

(Explanation of Modules to be Used)

A multiprocessor system according to the second embodiment is illustrated in schematic block diagram form in FIG. 4. The internal construction of a node controller having the address competition decision function is substantially the same as that in FIG. 1 and will not be described and a processor bus 120 and input/output units associated with the node controller 200 are principally depicted. Two or more processors 100a, 100b and 100c are coupled to the processor bus 120 which in turn is coupled to memory controller 500, I/O controller 510 and system coupling switch 520 through the node controller 200.

Prevailing between the processor bus 120 and the node controller 200 are a signal for receiving a request 600 from the processors 100a to 100c, a signal for receiving a snoop result, a signal for returning a response 620 from the node controller 200 to the processor bus 120 and a signal for exchanging data 630. Needless to say, other signals of various kinds exist but they do not have direct relation to the present invention and are not illustrated. The request 600 issued from each of the processors 100a to 100c is structured, as shown in FIG. 5, having fields of address 700 indicative of a memory or I/O to be accessed, transaction type 710, issuer identifier 720 indicative of an issuing processor 100 or thread and delay response identifier 730 used for identifying a transaction upon completion of a delay response.

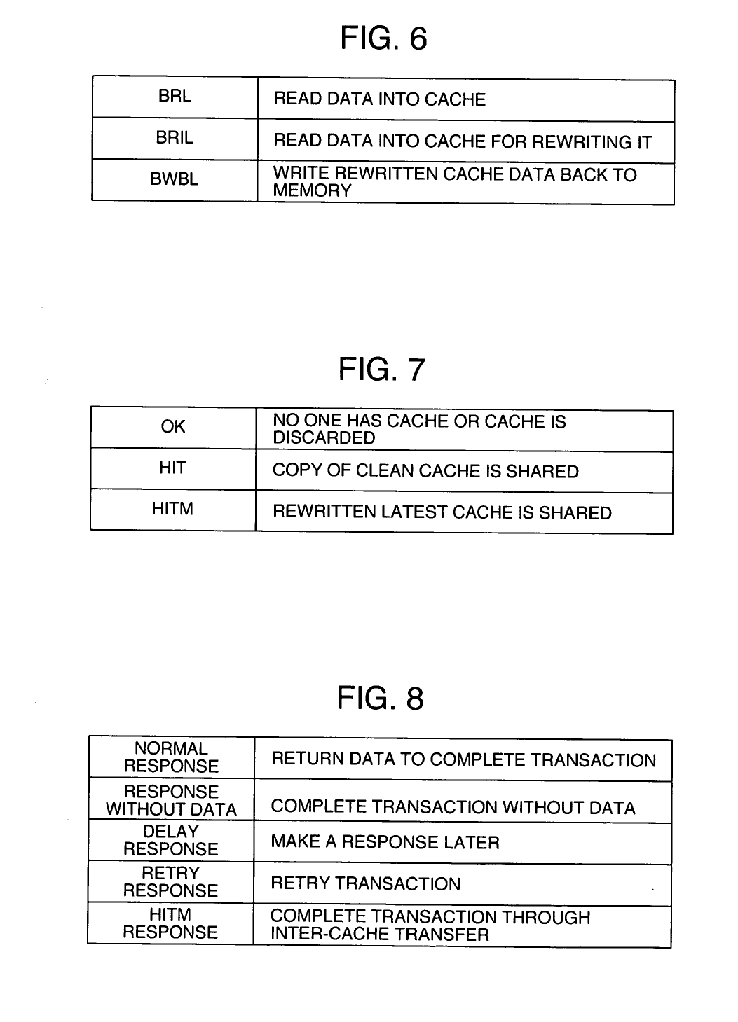

Various kinds of transactions can be enumerated as the transaction type 710 and some of them are shown in FIG. 6. In case the memory is accessed by using a write-back cache, BRL is issued when reading and BRIL is issued when writing and upon purge from the cache, BWBL is issued and written back to the memory. Otherwise, the transaction type 710 is often added with the size to be accessed but this is not related directly to the following description and is omitted herein.

The issuer identifier 720 may sometimes be structured by including, in addition to the address of processor 100, a core number in the case of a multi-core processor and an identifier of threading in the case of multi-threading. Even in such a case, the following description can remain unchanged. Further, for the sake of efficient elimination of the starvation, even a transaction issued from the same processor 100 can be applied with distinctive issuer identifiers in accordance with either read or write. By using the address 700 and issuer identifier 720 in combination, even the same transaction reissued through retry can be identified as being the identical one issued previously.

The result of snoop 610 can be sorted into types shown in FIG. 7. More specifically, OK stands when in respect of a request 600 from a processor 100, a different processor does not have data on the same cache line or discards it, HIT stands when, in respect of a read request, a cache not rewritten is shared and HITM stands when, in respect of a read or write request, the latest rewritten cache is modified. In the case of the HITM, inter-cache transfer occurs.

The response 620 can be sorted into types shown in FIG. 8. More specifically, a normal response is returned when data has already been present. In the case of the transaction type 710 being either BRL or BRIL, fetching data from the memory must be done in a case where retry is not determined and consequently, a delay response prevails in which a response is made after data has been returned. In the case of the transaction type 710 being BWBL, there is no need of returning data and therefore a response without data is used. To activate retry, a retry response is returned. The processor 100 receiving the retry response recommences starting from reissue of the request 600. In case the snoop result 610 asserts HITM, the transaction is completed by inter-cache transfer and hence an HTIM response is used. But the latest data 630 must be written back to the memory and therefore, the node controller 200 brings the memory into the latest state by using a write-back transaction.

(A Case where the Preceding Non-Protection Object of not Asserted for HITM)

Operation of the present invention will be described by using an input/output to the processor bus 120.

A request 600a destined for an address 700a is issued from the processor 100a. Assumptively, the transaction type 710a is BRL and the snoop result 610a is OK. Responsive to this, the node controller 200 returns a delay response as response 620a. Before completion of the request 600a, a request 600b is issued from the processor 100b to the same address 700a. It is also assumed that the transaction type 710b is BRL and the snoop result 610b is OK. Since the preceding request 600a has not been completed yet, the node controller 200 returns a retry response as response 620b. In due course, data corresponding to the request 600a is returned and the data 630a is returned eventually for completion.

Next, a request 600c is issued from the processor 100c to the same address 700a. Assumptively, the transaction type 710c is still BRL. Further subsequently, before a response to the request 600c is returned, the request 600b is reissued from the processor 100b. Since the processor 600a has a clean cache, the snoop result 610c for the request 600c is HIT. At that time, any incomplete transaction issued to the system so as to be destined for the address 700a does not exist but for avoidance of starvation of the request 600b retried precedently, the node controller 200 returns a retry response to the request 600c.

Meanwhile, the snoop result 610b for the request 600b subject to starvation avoidance protection is also HIT. Since the request 600c destined for the same address 700a does not exist at the time of issue of the request 600b, the node controller 200 makes a response to the effect of retry. But the request 600c eventually results in retry and address competition with a transaction in course of retry occurs. The node controller 200 stores this event.

Thereafter, the request 600c determined to be retried is reissued from the processor 100c. Further subsequently, the request 600b is reissued from the processor 100b before a response to the request 600c is returned. The snoop results 610c and 610b are both HIT. For avoidance of starvation of the request 600b, the request 600c is returned in the form of a retry response. In respect of the request 600b targeted by starvation prevention protection, the request 600c exists which is destined for the same address 700a as that of the request 600b. But because of twice successive address competition with the transaction in course of retry, the node controller 200 returns a delay response in order not to retry the request 600b but to issue it. In this manner, the request 600b subject to starvation protection can be issued.

Through a series of operations as above, starvation of the request 600b once determined to be retried can be avoided.

Points of the present invention reside in that when a transaction not subject to starvation protection and hence to be retried and a transaction subject to starvation protection are issued consecutively, the transaction of starvation protection-object is once retried and is then issued in the second occurrence. Retry in the first occurrence is performed by taking into consideration the fact that a preceding transaction expected to be retried will possibly be issued to the system through HITM. If issued in the first occurrence, a write-back transaction based on HITM and a read transaction are issued simultaneously, sometimes failing to guarantee the execution sequence of the transactions.

(A Case where the Preceding Non-Protection Object is Asserted for HITM)

Next, a case will be described in which a transaction issued before a request is made for a starvation protection object is asserted for HITM.

A request 600a is issued from the processor 100a to an address 700a. Assumptively, the transaction type 710a is read request BRIL for write and the snoop result 610a is OK. Responsive to this, the node controller 200 returns a delay response as response 620a.

Before completion of the request 600a, a request 600b destined for the same address 700a is issued from the processor 100b. Assumptively, the transaction type 710b is BRL and the snoop result 610b is OK. Since the preceding request 600a has not been completed yet, the node controller 200 returns a retry response as response 620b. In duce course, data for the request 600a is returned and data 630a is returned eventually for completion.

Next, a request 600c destined for the same address 700a is issued from the processor 100c. Assumptively, the transaction type 710c is also BRL. Further subsequently, the request 600b is reissued from the processor 100b before a response to the request 600c is returned. The snoop result 610c for the request 600c is HITM because the processor 600a has a rewritten cache. Originally, for avoidance of starvation of the request 600b retried previously, the node controller 200 is liable to return a retry response to the request 600c but the request 600c asserted for HITM cannot be retried and therefore it returns an HITM response as response 620c.

On the other hand, the snoop result 610b for the request 600b subject to starvation prevention protection is OK because inter-cache transfer has already occurred. Since the request 600c destined for the same address 700a existed at the time that the request 600b was issued, the node controller makes a response of retry. The preceding request 600c was not determined as to whether to be asserted for HITM at the time of issue of the request 600b and therefore the node controller 200 determines address competition with the transaction in course of retry and stores the request 600c. For the request 600c returning the HITM response, a write-back transaction is issued to the system in order to back-write the latest data 630 on the processor bus 120 to the memory.

Next, the request 600b is reissued from the processor 100b. The snoop result 610b is HIT because the processor 100c has already had a clean cache. But since the back-write transaction issued concomitantly with the HITM response of request 600c has not been completed yet, the node controller 200 again returns a retry response to the request 600b. In this manner, the request 600b subject to starvation protection keeps being retried until the preceding write back transaction is completed.

Through a series of operations as above, it can be guaranteed that only one transaction destined for the same address 700a is permitted for issue at a time. The foregoing description has been dedicated to the second embodiment of the invention.

### 3. Embodiment 3

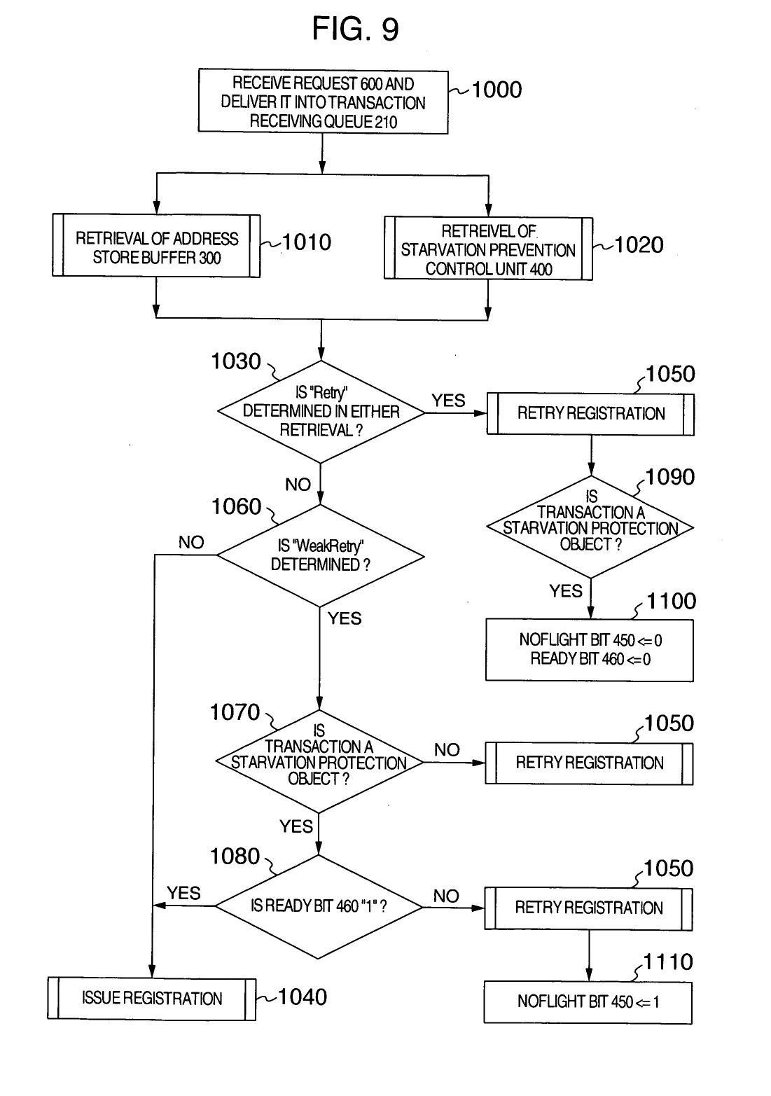

Next a third embodiment of the invention will be described which is directed to a method for preventing starvation in case of occurring address competition in the node controller of the multiprocessor system. A series of operations the node controller 200 performs on the multiprocessor shown in FIG. 1 will be described with reference to flowcharts of FIGS. 9 to 17. Reference will also be made to FIGS. 5 to 8 as necessary.

It is assumed that in the initial state, all of the valid bits 310 in the address store buffer 300, all of the valid bits 410 in the starvation prevention control unit 400, the NOFLIGHT bit 450 and the READY bit 460 are zero. It is also presupposed that comparison of two addresses in the following procedures is carried out in unit of cache line unless especially notified to the contrary.

(Flowchart in Request Phase)

Procedures in the request phase are shown in FIGS. 9 to 13.

Especially, a basic flowchart of request phase is shown in FIG. 9.

In step 1000, the request phase is started upon arrival of a request 600 from the processor 100 through the processor bus 120. The node controller 200 en-queues the request 600 in the transaction receiving queue 210 and executes steps 1010 and 1020 in parallel. The request 600 is comprised of fields as shown in FIG. 5.

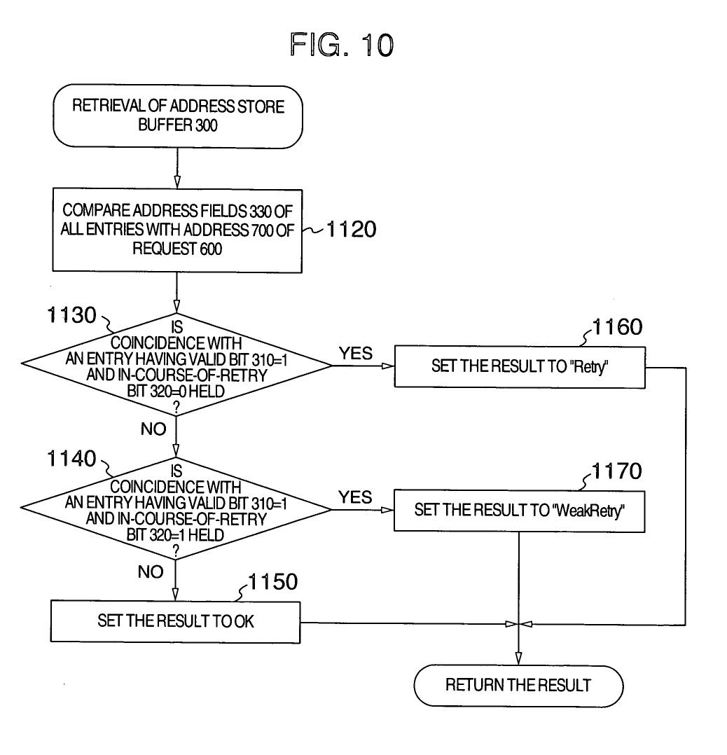

In the step 1010, the address store buffer 300 is retrieved. The buffer returns any one of “OK”, “Retry” and “Weak Retry” as a result of retrieval. Details are shown in FIG. 10. The program proceeds to step 1030.

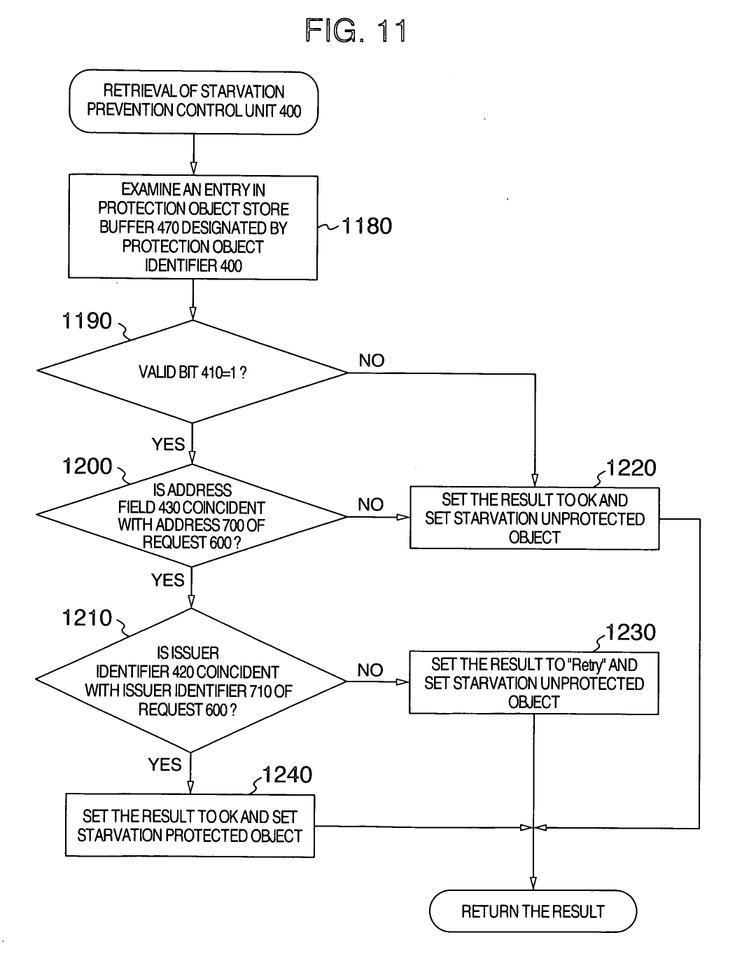

In the step 1020, the starvation prevention control unit 400 is retrieved. The control unit returns either “OK” or “Retry” and either “object subject to starvation protection” or “object not subject to starvation protection” as a result of retrieval. Details are shown in FIG. 11. The step 1020 is also followed by the step 1030.

In the step 1030, it is decided whether “Retry” is determined in either the retrieval result of step 1010 or the retrieval result of step 1020. In case “Retry” is determined in either retrieval result, step 1050 is executed and thereafter the program proceeds to step 1090. Otherwise, the program proceeds to step 1060.

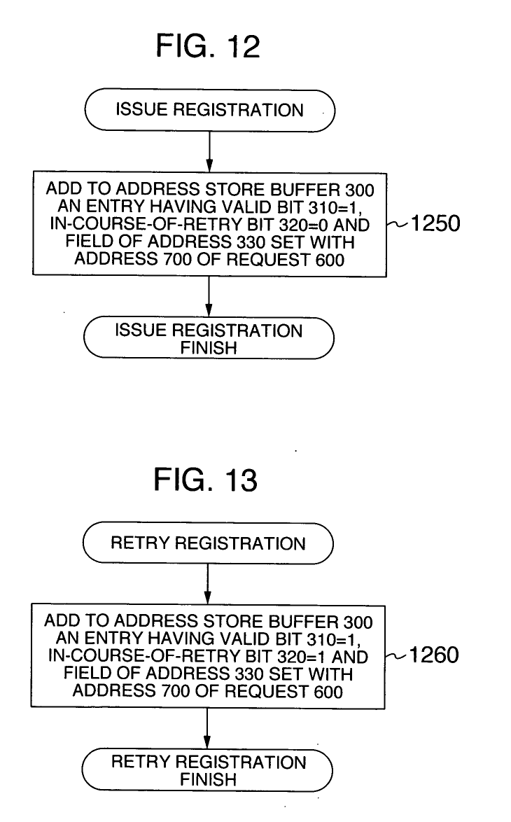

In step 1040, issue registration to the address store buffer 300 is carried out. Details are shown in FIG. 12.

In step the 1050, retry registration to the address store buffer 300 is carried out. Details are shown in FIG. 13.

In the step 1060, it is decided whether “Weak Retry” is determined in the step 1010. In case of “Weak Retry”, the program proceeds to step 1070 but otherwise to the step 1040.

In the step 1070, it is decided whether “object subject to starvation protection” is determined in the step 1020. If “object subject to starvation protection” is determined, the program proceeds to step 1080 but otherwise the step 1050 is executed to end the process or phase.

In the step 1080, it is decided whether the READY bit 460 in starvation prevention control unit 400 is “1”. If “1” stands, the program proceeds to the step 1040. If not, the step 1050 is executed and thereafter, the program proceeds to step 1110.

In the step 1090, it is decided whether “object subject to starvation protection” is determined in the step 1020. If “object subject to starvation protection” is determined, the program proceeds to step 1100 but otherwise the phase ends.

In the step 1100, the NOFLIGHT bit 450 and READY bit 460 are cleared to “0”.

In the step 1110, the NOFLIGHT bit 450 is set to “1”.

Subsequently, the step 1010 “retrieval of address store buffer 300” will be detailed with reference to a flowchart of FIG. 10.

In step 1120, fields of address 330 of all entries in the address store buffer 300 are compared with an address 700 of the request 600. This step is followed by step 1130.

In the step 1130, it is decided whether coincidence occurs in an entry indicating in-course-of-issue state (having valid bit 310=1 and in-course-of-retry bit=0). If the coincidence stands, the program proceeds to step 1160 but otherwise to step 1140.

In the step 1140, it is decided whether coincidence occurs in an entry indicating in-course-of-retry state (having valid bit 310=1 and in-course-of-retry bit=1). If the coincidence stands, the program proceeds to step 1170 but otherwise to step 1150.

In the step 1150, the result of retrieval of address store buffer 300 is set to “OK”.

In the step 1160, the retrieval result of address store buffer 300 is set to “Retry”.

In the step 1170, the retrieval result of address store buffer 300 is set to “Weak Retry”.

Next, details of the step 1020 “retrieval of starvation prevention control unit 400” will be described with reference to a flowchart of FIG. 11.

In step 1180, en entry in protection object registration buffer 470 designated by a protection object identifier 440 is examined. This step is followed by step 1190.

In the step 1190, the valid bit 410 is decided as to whether to be “1”. If “1” stands, the program proceeds to step 1200.

In the step 1200, it is decided whether the field of address 430 coincides with the address 700 of request 600. In the case of coincidence, the program proceeds to step 1210 but in the case of non-coincidence, the program proceeds to step 1220.

In the step 1210, it is decided whether the issuer identifier 420 coincides with an issuer identifier 710 of request 600. If coincident, the program proceeds to step 1240 but if non-coincident, the program proceeds to step 1230.

In the step 1220, the retrieval result is set to “OK” to determine “object not subject to starvation protection”.

In the step 1230, the retrieval result is set to “Retry” to determine “object not subject to protection from starvation”.

In the step 1240, the retrieval result is set to “OK” to determine “object subject to protection from starvation”.

The step 1040 “issue registration” will now be described in greater detail with reference to a flowchart of FIG. 12.

In step 1250, the request 600 is registered as being in course of issue in the address store buffer 300. An entry having valid bit 310=1, in-course-of-retry bit 320=0 and field of address 330=address 700 is added to the address store buffer 300.

Subsequently, details of the step 1050 “retry registration” will be described with reference to a flowchart of FIG. 13.

In step 1260, the request 600 is registered as being in course of retry in the address store buffer 300. An entry having valid bit 310=1, in-course-of-retry bit 320=1 and field of address 330=address 700 is added to the address store buffer 300.

The flowcharts set forth so far prevail in the request phase.

(Flowchart of Snoop Phase)

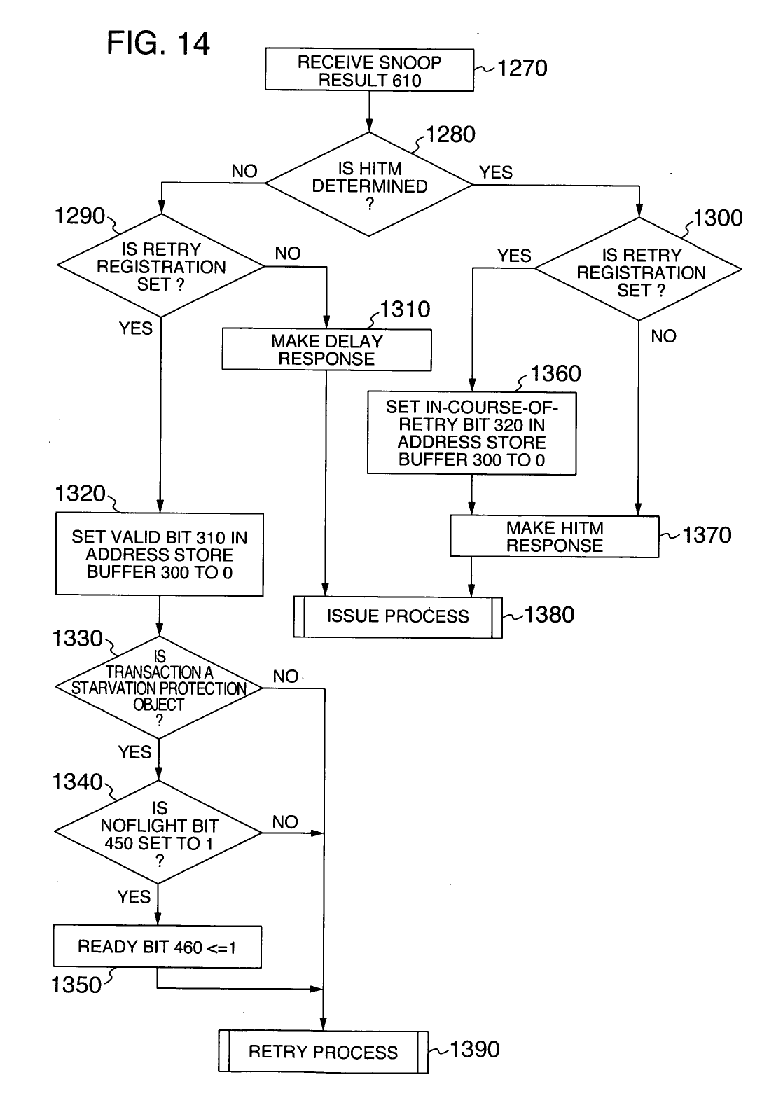

Next, procedures in the snoop phase will be described with reference to FIGS. 14 to 16.

Illustrated in FIG. 14 is a basic flowchart of the snoop phase.

In step 1270, a snoop result 610 is received on the processor bus 120 and the snoop phase is started. The correspondence between the snoop result 610 and the request 600 is made in order of issue. This step is followed by step 1280.

In the step 1280, it is decided whether the snoop result 610 is HITM. If the HITM stands, the program proceeds to step 1300 but if not, to step 1290.

In the step 1290, it is decided whether retry registration was effected in the request phase. In case of completion of the retry registration, the program proceeds to step 1320 but otherwise to step 1310.

In the step 1300, it is decided whether retry registration was effected in the request phase. In case of completion of the retry registration, the program proceeds to step 1360 but otherwise to step 1370.

In the step 1310, a delay response is made. The response control unit 230 of node controller 200 returns the delay response as response 620. This step is followed by step 1380.

In the step 1320, the address store buffer 300 is de-queued. The valid bit 310 of the corresponding entry is set to “0”. The program proceeds to step 1330.

In the step 1330, it is decided whether the request 600 is determined as a starvation protection object in the step 1020 of request phase. If the starvation protection object stands, the program proceeds to step 1340. If not, the program proceeds to step 1390.

In the step 1340, it is decided whether the NOFLIGHT bit 450 in starvation prevention control unit 400 is “1”. If “1” stands, the program proceeds to step 1350 but otherwise, to the step 1390.

In the step 1350, the READY bit 460 in starvation prevention control unit 400 is set to “1”. This step is followed by the step 1390.

In the step 1360, the corresponding entry in the address store buffer 300 is changed from “in course of retry” to “in course of issue”. The in-course-of-retry bit 320 in the corresponding entry is changed from “1” to “0”. This step is followed by the step 1370.

In the step 1370, an HITM response is made. The response control unit 230 of node controller 200 returns the HITM response as response 620. Then, the program proceeds to the step 1380.

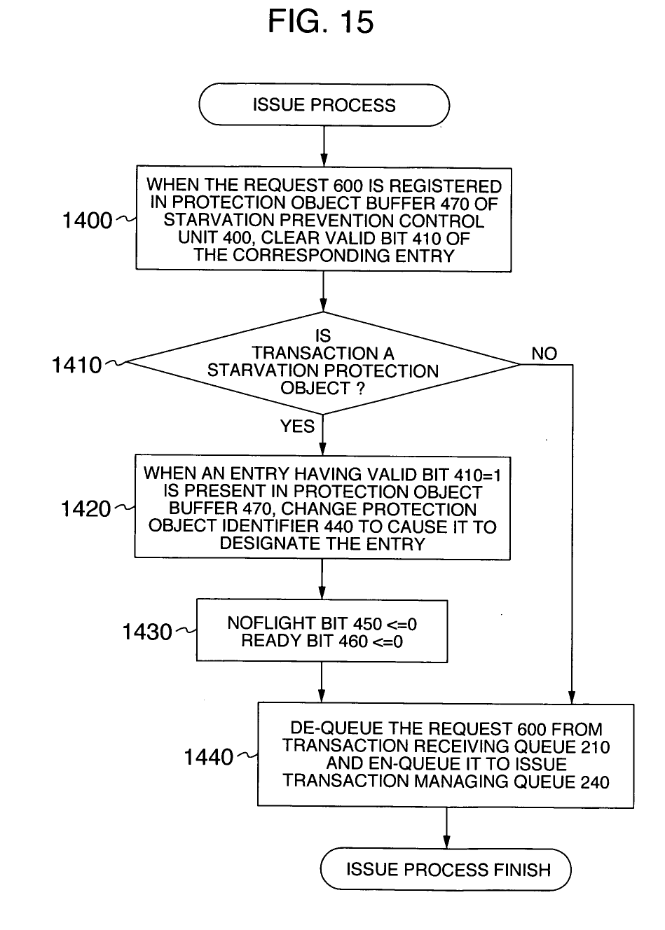

In the step 1380, an issue process is performed. Details of the issue process are shown in FIG. 15.

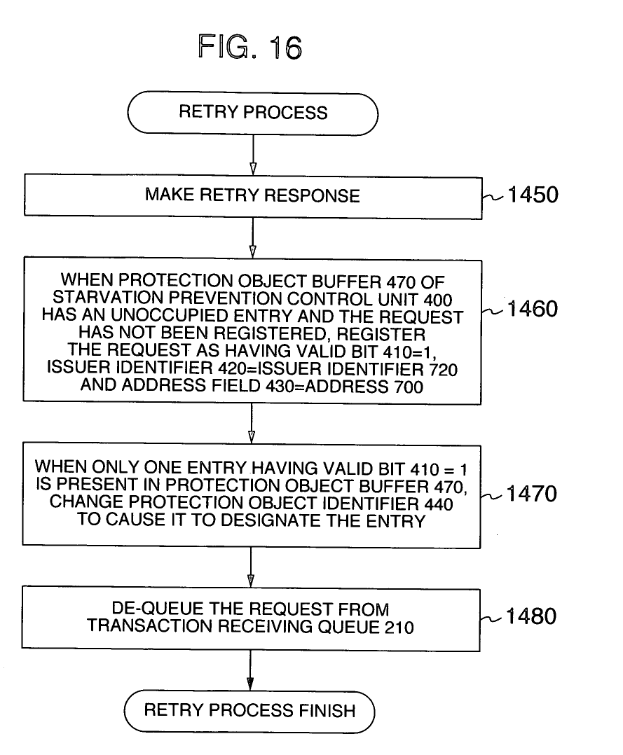

In the step 1390, a retry process is performed. Details of the retry process are shown in FIG. 16.

Next, details of the step 1380 “issue process” will be described with reference to FIG. 15.

In step 1400, the request 600 is de-queued from the starvation prevention control unit 400.

When, in an entry having valid bit 410=1 in the protection object buffer 470, the issuer identifier 420 and field of address 430 coincide with the issuer identifier 720 and address 700 of the request 600, respectively, the valid bit 410 is set to “0”. This step is followed by step 1410.

In the step 1410, it is decided whether a starvation prevention object is determined in the step 1020 in the request phase. If the starvation protection object stands, the program proceeds to step 1420. If the starvation protection object does not stand, the program proceeds to step 1440.

In the step 1420, an object designated by the protection object identifier 440 is changed. In case an entry having the valid bit 410=1 exists in the protection object buffer 470, the protection object identifier 440 is so changed as to designate that entry. If there are plural entries having the valid bit 410=1, it is preferable that only a specified entry be unlikely to be selected. As a selection method to this end, the round robin algorithm may be conceivable. The step 1420 is followed by step 1430.

In the step 1430, the NOFLIGHT bit 450 and READY bit 460 are cleared. The program proceeds to the step 1440.

In the step 1440, the request 600 is de-queued from the transaction receiving queue 210 and is then en-queued to the issue transaction managing queue 240. In case the snoop result 610 indicates the HITM, the transaction type is changed to write-back. Through the above steps, the issue process ends.

Next, details of the step 1390 “Retry process” will be described with reference to FIG. 16. In step 1450, a retry response is made. The response control unit 230 of node controller 200 returns the retry response as response 620. The program proceeds to step 1460.

In the step 1460, the request 600 is registered in the protection object buffer 470. When the protection object buffer 470 has an unoccupied entry and the request 600 is not registered, the entry is made to have the valid bit 410=1, issuer identifier 420=issuer identifier 720 and field of address 430=address 700 and is registered. Then, the program proceeds to step 1470.

In the step 1470, an object designated by the protection object identifier 440 is changed. When the protection object buffer 470 has only one entry having the valid bit 410=1, the protection object identifier 440 is so changed as to designate that entry. The program proceeds to step 1480.

In the step 1480, the request 600 is de-queued from the transaction receiving queue 210. Through the above steps, the retry process is completed.

The flowcharts set forth so far prevail in the snoop phase.

(Flowchart of Completion Phase)

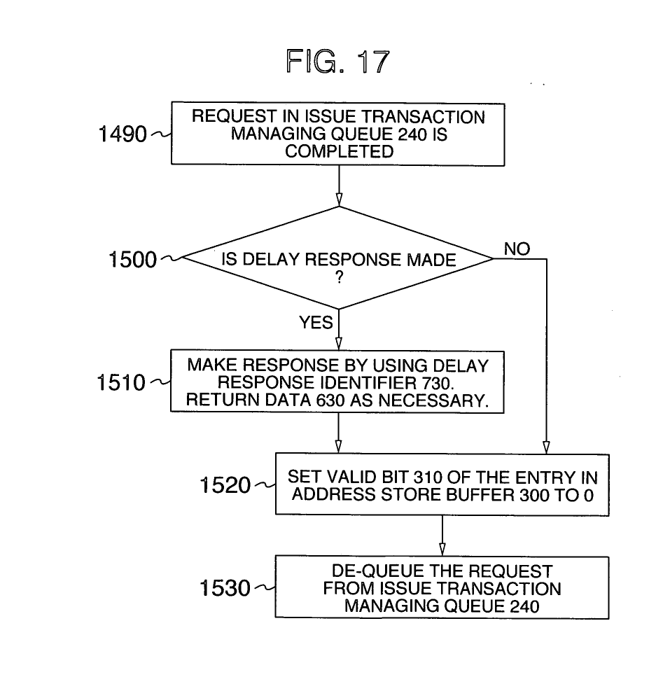

Subsequently, a flowchart of the completion phase is illustrated in FIG. 17.

In step 1490, completion of the transaction in the issue transaction managing queue 240 activates commencement of the completion phase. A notice of completion is given by reception of ACK or arrival of data return. This step is followed by step 1500.

In the step 1500, it is decided whether the delay response is made in the snoop phase. If the delay response has been made, the program proceeds to step 1510 but otherwise to step 1520.

In the step 1510, responsive to the delay response, the transaction is completed. If the delay response identifier 730 indicates existence of data 630, the data is returned. The program proceeds to the step 1520.

In the step 1520, the request is de-queued from the address store buffer 300. The valid bit 310 in the corresponding entry is cleared to “0”. This step is followed by step 1530.

In the step 1530, the request is de-queued from the issue transaction managing queue 240. Through the above steps, the completion phase ends.

The flowcharts set forth so far prevail in the completion phase.

Through a series of operations as above, the transaction starvation prevention and address competition decision can be assured.

The third embodiment of the invention can be made as described so far.

According to the present invention, the retry decision due to the address competition can be made without waiting for the snoop result. The latency up to the issue in the event that the transaction is not retried can be shortened by 2 to 3 cycles. Further, the address competition decision unit can be constructed of a pipeline of fixed cycle. In comparison with a pipeline of variable length adapted for making an address competition decision by confirming the awaited result of retry of the preceding transaction, the gate scale can be reduced.

It should be further understood by those skilled in the art that although the foregoing description has been made on embodiments of the invention, the invention is not limited thereto and various changes and modifications may be made without departing from the spirit of the invention and the scope of the appended claims.

1. A multiprocessor system comprising:
a plurality of processors;
a memory;
a node controller functioning to permit a preceding access request and prohibit a succeeding access request when access requests to said memory from said plurality of processors compete with one another; and
a processor bus for coupling at least two of said plural processors to said node controller,
wherein said node controller has:
the function of identifying, when a processor concerned in a memory access request once issued but prohibited reissues the memory access request destined for the same memory before said prohibited access request is finally permitted, said reissued request as a protection object; and
the function of identifying, as an in-course-of-retry access request, an access request which is issued from the processor other than the requester of said memory access, competes with said memory access request identified as the protection object and has not been permitted as an access request, and
wherein when said memory access request identified as the protection object sequentially competes twice with said in-course-of-retry access request, said memory access request identified as the protection object is permitted.

2. A multiprocessor system according to claim 1, wherein said node controller includes a retry decision unit having an in-course-of-retry bit for discriminating said in-course-of-retry access request.

3. A multiprocessor system according to claim 1 further comprising a buffer for storing information for discriminating between states before and after access request permission of said memory access request.

4. A multiprocessor system according to claim 2,
wherein said node controller includes an address store buffer for storing an issuer address of said memory access request; and
wherein when said memory access request competes with a preceding different access request destined for the same memory, a state “Weak Retry” is determined if said preceding access request is one for which said in-course-of-retry bit is valid and a state “Retry” is determined if said preceding access request is one for which said in-course-of-retry bit is invalid, so that the decision result of “Weak Retry” or “Retry” is transmitted to a requester of said preceding access request.

5. A multiprocessor system according to claim 4, wherein said node controller includes a starvation prevention control unit for avoiding starvation of a request from a specified processor and said starvation prevention control unit stores a NOFLIGHT bit indicating that an access request in competition with said access request of protection object has not been issued to the system and a READY bit indicating that said access request of protection object is permissible.

6. A multiprocessor according to claim 1, wherein said at least two processors and said node controller are formed on a same chip.

7. A node controller coupled with a processor bus to which a plurality of processors are coupled, an I/O controller, a memory controller for connection of a memory and a system coupling switch, said node controller having:
the function of permitting a preceding access request and prohibiting a succeeding access request when access requests from said plurality of processors to said memory received through said processor bus compete with one another;
the function of identifying, when a processor concerned in a memory access request once issued but prohibited reissues the memory access request destined for the same memory before said prohibited access request is finally permitted, said reissued request as a protection object; and
the function of identifying, as an in-course-of-retry access request, an access request which is issued from the processor other than the requester of said memory access, competes with said memory access request identified as the protection object and has not been permitted as an access request, so that when said memory access request identified as the protection object sequentially competes twice with said in-course-of-retry access request, said memory access request identified as the protection object is permitted.

8. A node controller according to claim 7 comprising a retry decision unit having an in-course-of-retry bit for discriminating said in-course-of-retry access request.

9. A node controller according to claim 7 comprising a buffer for storing information for discriminating between states before and after access request permission of said memory access request.

10. A node controller according to claim 7 comprising an address store buffer for storing an issuer address of said memory access request, wherein when said memory access request competes with a preceding different access destined for the same address, a state “Weak Retry” is determined if said preceding access request is one for which said in-course-of-retry bit is valid and a state “Retry” is determined if said preceding access request is one for which said in-course-of-retry bit is invalid, so that the decision result of “Weak Retry” or “Retry” is transmitted to a requester of said preceding access request.

11. A node controller according to claim 10 further comprising a starvation prevention control unit for avoiding starvation of a request from a specified processor, wherein said starvation prevention control unit stores a NOFLIGHT bit indicating that an access request in competition with said access request of protection object has not been issued to the system and a READY bit indicating that said access request of protection object is permissible.

12. A node controller according to claim 7, wherein said at least two processors and said node controller are formed on a same chip.

13. A node controller which can be coupled with a processor bus to which a plurality of processors are coupled, an I/O controller, a memory controller for connection of a memory and a system coupling switch,
wherein said node controller has the function of transmitting/receiving a transaction issue request the processor issues and a response to said transaction issue request through said processor bus; and
wherein when transaction issue requests destined for the same address compete with one another, said node controller transmits to said processor bus a response for permitting a preceding transaction issue request and a response for prohibiting a succeeding transaction issue request and responsive to a transaction issue request reissued to the same address by a processor having received said prohibition response, transmits to said processor bus a response to the effect that for the transaction issue request firstly reissued, said transaction is not issued and a response to the effect that for the transaction issue request twice or more reissued, said transaction is issued.

14. An address competition decision method to be executed on a node controller which is coupled to a processor bus coupled with a plurality of processors, an I/O controller, a memory controller for connection of a memory and a system coupling switch and which has the function of, when access requests from said plurality of processors to said memory compete with one another, permitting a preceding access request and returning retry to a succeeding access request, comprising the steps of:
comparing, in respect of an access request to said memory, an address of a requester of said access request with an address stored in an address store buffer and deciding whether an address competition occurs in an entry having the in-course-of-retry bit being set;
identifying, as a starvation protection object, a memory access request reissued to the same memory by a processor having received said retry before said access request is permitted;
deciding, when the access request issued from the requester processor of said starvation protection object is in address competition with only an entry having said set in-course-of-retry bit in said address store buffer, whether said address competition is in the second occurrence; and
permitting said access request when said address competition is in the second occurrence.

15. An address competition decision method according to claim 14,
wherein said node controller has an address store buffer for storing an address of an issuer of said memory access request; and
wherein when said memory access request competes with a preceding different access request destined for the same memory, a state “Weak Retry” is determined if said preceding access request is one for which said in-course-of-retry bit is valid and a state “Retry” is determined if said preceding access request is one for which said in-course-of-retry bit is invalid, so that the decision result of “Weak Retry” or “Retry” is transmitted to the requester of said preceding access request.
